(19) United States
(12) Patent Application Publication
(10) Pub. No.: US 2025/0245477 A1
(43) Pub. Date: Jul. 31, 2025

(54) MACHINE LEARNING-BASED REVERSE LOGISTICS PROCESSING

(71) Applicant: Dell Products L.P., Round Rock, TX (US)

(72) Inventors: Ajay Maikhuri, Bangalore (IN); Dhilip S. Kumar, Bangalore (IN); Bhanu Murthy Modali, Hyderabad (IN)

(21) Appl. No.: 18/422,257

(22) Filed: Jan. 25, 2024

(51) Int. Cl. G06N 3/0442

(52) U.S. Cl. CPC G06N 3/0442

(57) ABSTRACT

An apparatus comprises at least one processing device configured to generate a first data structure characterizing issues encountered on one or more information technology assets and to generate a second data structure by parsing the first data structure utilizing a first machine learning model, the second data structure characterizing a context of the issues encountered on the information technology assets. The at least one processing device is also configured to generate a third data structure utilizing a second machine learning model which takes as input the second data structure, the third data structure characterizing recommendations for different types of reverse logistics processing to be utilized for the information technology assets. The at least one processing device is further configured to control a routing of a given one of the information technology assets from a first to a second location based at least in part on the generated third data structure.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Support platforms may be utilized to provide various services for sets of managed computing devices. Such services may include, for example, troubleshooting and remediation of issues encountered on computing devices managed by a support platform. This may include periodically collecting information on the state of the managed computing devices, and using such information for troubleshooting and remediation of the issues. Such troubleshooting and remediation may include receiving requests to provide servicing of hardware and software components of computing devices. For example, users of computing devices may submit service requests to a support platform to troubleshoot and remediate issues with hardware and software components of computing devices. Such requests may be for servicing under a warranty or other type of service contract offered by the support platform to users of the computing devices. Support platforms may also provide functionality for testing managed computing devices.

### SUMMARY

Illustrative embodiments of the present disclosure provide techniques for machine learning-based reverse logistics processing.

In one embodiment, an apparatus comprises at least one processing device comprising a processor coupled to a memory. The at least one processing device is configured to generate a first data structure characterizing one or more issues encountered on one or more information technology assets and to generate a second data structure by parsing the first data structure utilizing a first machine learning model, the second data structure characterizing a context of the one or more issues encountered on the one or more information technology assets. The at least one processing device is also configured to generate a third data structure utilizing a second machine learning model, the second machine learning model taking as input the second data structure, the third data structure characterizing one or more recommendations for one or more types of reverse logistics processing to be utilized for the one or more information technology assets. The at least one processing device is further configured to control at least a portion of a routing of at least a given one of the one or more information technology assets from a first location to a second location based at least in part on the generated third data structure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based reverse logistics processing in an illustrative embodiment.

FIG. 2 is a flow diagram of an exemplary process for machine learning-based reverse logistics processing in an illustrative embodiment.

FIG. 3 shows a system configured to implement reverse logistics fulfilment for a support processing platform in an illustrative embodiment.

FIGS. 4A and 4B show a table illustrating various reverse logistics fulfilment scenarios in an illustrative embodiment.

FIG. 5 shows an implementation of reverse logistics fulfilment for a refurbishment scenario in an illustrative embodiment.

FIG. 6 shows an implementation of reverse logistics fulfilment for a repacking scenario in an illustrative embodiment.

FIG. 7 shows implementation of reverse logistics fulfilment for a deconstruction and salvage scenario in an illustrative embodiment.

FIG. 8 shows a system implementing an intelligent reverse logistics fulfilment framework in an illustrative embodiment.

FIG. 9 shows an architecture of a bi-directional long short-term memory neural network which may be utilize for intent and context analysis in an illustrative embodiment.

FIG. 10 shows a framework for conversational intent analysis in an illustrative embodiment.

FIG. 11 shows a table illustrating return reasons and their associated context or intent in an illustrative embodiment.

FIG. 12 shows am architecture of a random forest classifier for reverse logistics fulfilment option prediction in an illustrative embodiment.

FIG. 13 shows a framework for intent classification in an illustrative embodiment.

FIG. 14 shows pseudocode for importing libraries utilized in implementing a multi-class reverse logistics fulfilment prediction engine utilizing machine learning in an illustrative embodiment.

FIG. 15 shows pseudocode for creating a training dataset for a machine learning model used in implementing a multi-class reverse logistics fulfilment prediction engine in an illustrative embodiment.

FIG. 16 shows pseudocode for creating and training the machine learning model used in implementing a multi-class reverse logistics fulfilment prediction engine in an illustrative embodiment.

FIG. 17 shows an architecture of a dense neural network used in implementing a multi-class reverse logistics fulfilment prediction engine in an illustrative embodiment.

FIG. 18 shows pseudocode for importing libraries and reading a transaction history for implementing a multi-class reverse logistics fulfilment prediction engine utilizing deep learning in an illustrative embodiment.

FIG. 19 shows pseudocode for data preprocessing including encoding of textual categorical values in training data for a deep learning multi-layer dense neural network used in implementing a multi-class reverse logistics fulfilment prediction engine in an illustrative embodiment.

FIG. 20 shows pseudocode for data preprocessing including dimensionality reduction and scaling of training data for a deep learning multi-layer dense neural network used in implementing a multi-class reverse logistics fulfilment prediction engine in an illustrative embodiment.

FIG. 21 shows pseudocode for creating a training dataset for a deep learning multi-layer dense neural network used in implementing a multi-class reverse logistics fulfilment prediction engine in an illustrative embodiment.

FIG. 22 shows pseudocode for creating for a deep learning multi-layer dense neural network used in implementing a multi-class reverse logistics fulfilment prediction engine in an illustrative embodiment.

FIGS. 23 and 24 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

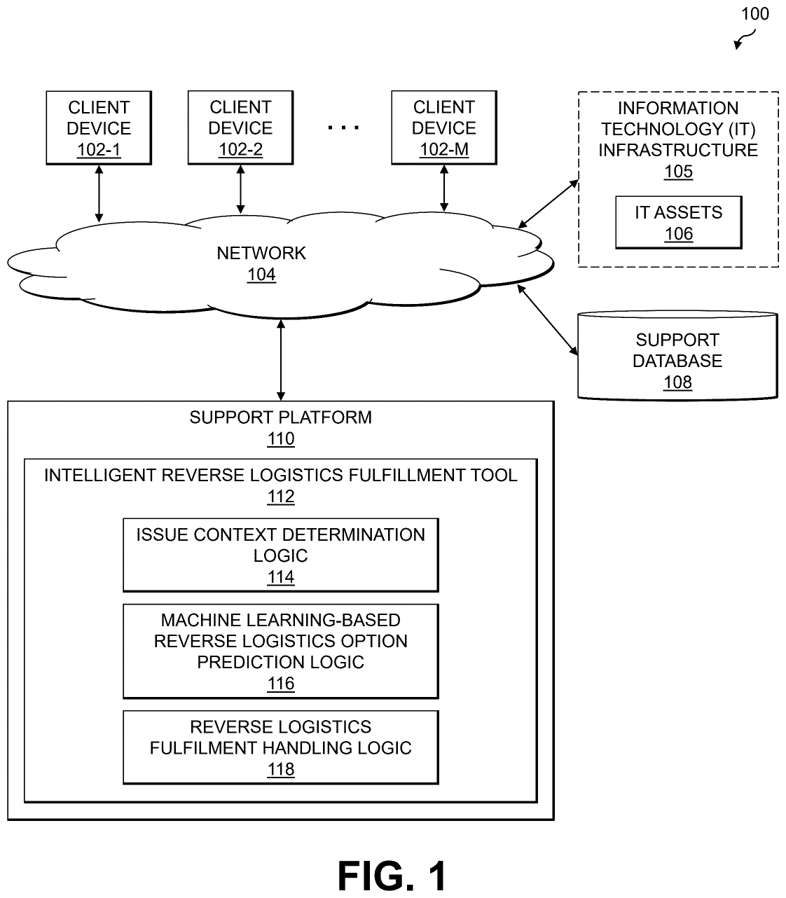

FIG. 1 shows an information processing system 100 configured in accordance with an illustrative embodiment. The information processing system 100 is assumed to be built on at least one processing platform and provides functionality for machine learning-based reverse logistics processing. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a support database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for managing IT assets 106 of the IT infrastructure 105 operated by that enterprise. Users of the enterprise associated with different ones of the client devices 102 may utilize the support platform 110 in order to manage problems or other issues which are encountered on different ones of the IT assets 106. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The support database 108 is configured to store and record various information that is utilized by the support platform 110. Such information may include, for example, information that is collected from multiple data sources and which is processed and stored for use in performing reverse logistics processing by the support platform 110. This may include information related to historical issues encountered on the client devices 102, the IT assets 106 or other products (e.g., computers or other IT assets) which are serviced by the support platform 110, as well as the resolutions of such historical issues (e.g., including, for example, the reverse logistics processing used when returns are initiated). The support database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to manage servicing of the IT assets 106 of the IT infrastructure 105, the client devices 102 themselves, other products which are serviced by the support platform 110, etc. The client devices 102 may be configured to access or otherwise utilize the support platform 110 to track and manage reverse logistics processing for different ones of the IT assets 106 (or other products, such as the client devices 102 themselves). In some embodiments, the client devices 102 are assumed to be associated with system administrators, IT managers, support engineers or other authorized personnel responsible for managing or performing servicing of the IT assets 106. In some embodiments, the IT assets 106 of the IT infrastructure 105 are owned or operated by the same enterprise that operates the support platform 110. In other embodiments, the IT assets 106 of the IT infrastructure 105 may be owned or operated by one or more enterprises different than the enterprise which operates the support platform 110 (e.g., a first enterprise provides support for multiple different customers, business, etc.). Various other examples are possible.

In some embodiments, the client devices 102 and/or the IT assets 106 of the IT infrastructure 105 may implement host agents that are configured for automated transmission of information with the support platform 110. It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements an intelligent reverse logistics fulfillment tool 112. The intelligent reverse logistics fulfilment tool 112 comprises issue context determination logic 114, machine learning-based reverse logistics option prediction logic 116, and reverse logistics fulfilment handling logic 118. The issue context determination logic 114 is configured to utilize one or more machine learning models to determine a context of one or more issues encountered on one or more of the IT assets 106. The machine learning-based reverse logistics option prediction logic 116 is configured to utilize one or more machine learning models to generate recommendations for different types of reverse logistics processing to be utilized for different ones of the IT assets 106. The reverse logistics fulfilment handling logic 118 is configured to control routing of the IT assets 106 between different locations based at least in part on the recommended types of reverse logistics processing to be utilized for the different ones of the IT assets 106.

At least portions of the intelligent reverse logistics fulfilment tool 112, the issue context determination logic 114, the machine learning-based reverse logistics option prediction logic 116, and the reverse logistics fulfilment handling logic 118 may be implemented at least in part in the form of software that is stored in memory and executed by a processor.

It is to be appreciated that the particular arrangement of the client devices 102, the IT infrastructure 105, the support database 108 and the support platform 110 illustrated in the FIG. 1 embodiment is presented by way of example only, and alternative arrangements can be used in other embodiments. As discussed above, for example, the support platform 110 (or portions of components thereof, such as one or more of the intelligent reverse logistics fulfilment tool 112, the issue context determination logic 114, the machine learning-based reverse logistics option prediction logic 116, and the reverse logistics fulfilment handling logic 118) may in some embodiments be implemented internal to one or more of the client devices 102 and/or the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the support database 108 and the support platform 110 or components thereof (e.g., the intelligent reverse logistics fulfilment tool 112, the issue context determination logic 114, the machine learning-based reverse logistics option prediction logic 116, and the reverse logistics fulfilment handling logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the support database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the support database 108 and the support platform 110, or portions or components thereof, to reside in different data centers. Numerous other distributed implementations are possible. The support platform 110 can also be implemented in a distributed manner across multiple data centers.

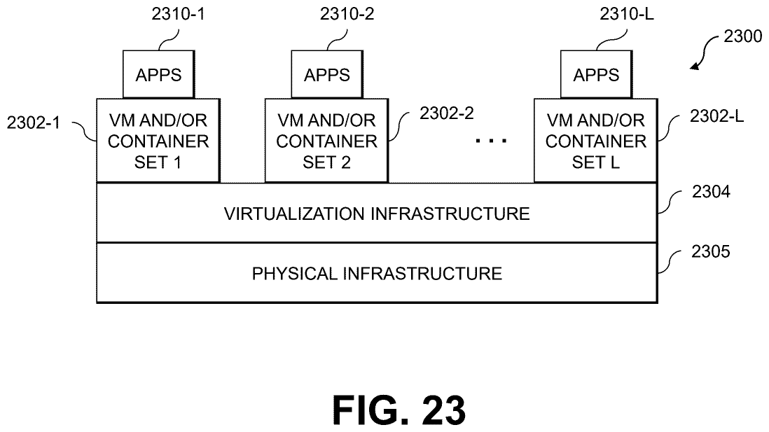

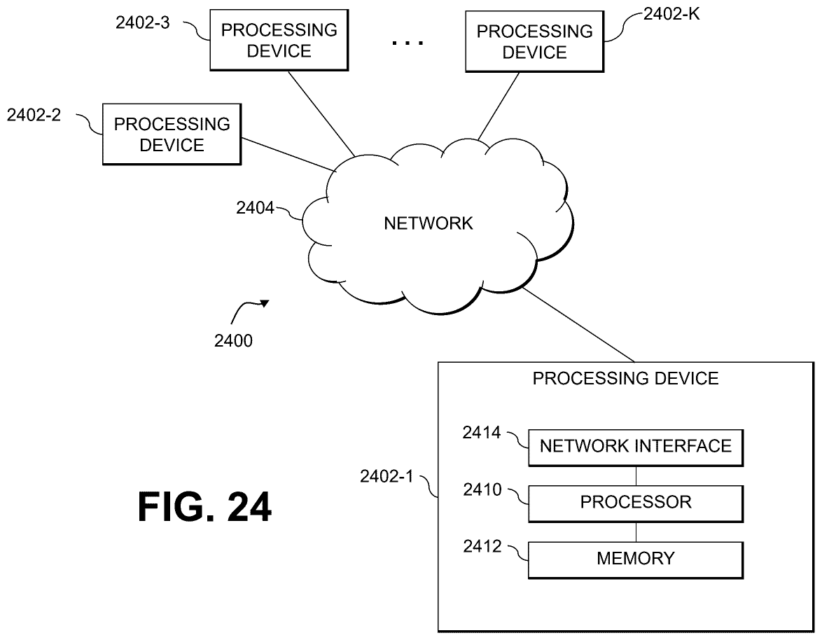

Additional examples of processing platforms utilized to implement the support platform 110 and other components of the information processing system 100 in illustrative embodiments will be described in more detail below in conjunction with FIGS. 23 and 24.

It is to be understood that the particular set of elements shown in FIG. 1 for machine learning-based reverse logistics processing is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

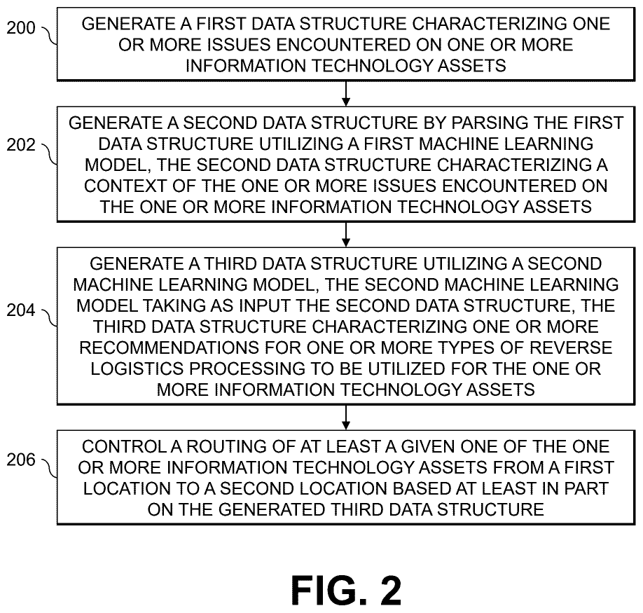

An exemplary process for machine learning-based reverse logistics processing will now be described in more detail with reference to the flow diagram of FIG. 2. It is to be understood that this particular process is only an example, and that additional or alternative processes for machine learning-based reverse logistics processing may be used in other embodiments.

In this embodiment, the process includes steps 200 through 206. These steps are assumed to be performed by the support platform 110 utilizing the intelligent reverse logistics fulfilment tool 112, the issue context determination logic 114, the machine learning-based reverse logistics option prediction logic 116, and the reverse logistics fulfilment handling logic 118. The process begins with step 200, generating a first data structure characterizing one or more issues encountered on one or more IT assets. As used herein, the term “data structure” is intended to be construed broadly, and may include one or more tables, arrays, numerical representations of textual data suitable for input to machine learning models, etc. Further, the first, second and/or third data structures described herein may be different portions of a larger data structure.

In step 202, a second data structure is generated by parsing the first data structure utilizing a first machine learning model, the second data structure characterizing a context of the one or more issues encountered on the one or more IT assets. The context may characterize a source or cause of the one or more issues encountered on the one or more IT assets. In some embodiments, the first data structure comprises text data, and the first machine learning model may comprise one or more natural language understanding (NLU) machine learning models configured to determine sentiment of the text data. The first machine learning model may comprise a bi-directional recurrent neural network (RNN) with long short-term memory (LSTM). The text data may comprise user-generated descriptions of the one or more issues encountered on the one or more information technology assets, support engineer feedback related to the one or more issues encountered on the one or more information technology assets, a description of a physical condition of the one or more information technology assets, etc.

In step 204, a third data structure is generated utilizing a second machine learning model, where the second machine learning model takes as input the second data structure (and, in some embodiments, the first data structure). The third data structure characterizes one or more recommendations for one or more types of reverse logistics processing to be utilized for the one or more IT assets. The second machine learning model may comprise a multi-class classifier configured to predict a given class from among a set of two or more classes, the set of two or more classes comprising two or more different reverse logistics fulfilment options. The two or more different reverse logistics fulfilment options may comprise at least two of repair, refurbish, recycle, repacking, remanufacturing, deconstruction and salvage, and disposal. In some embodiments, the second machine learning model comprises a random forest classifier comprising a plurality of decision trees trained on at least one of different data samples and different data features, the random forest classifier being configured to perform aggregation of class predictions from the plurality of decision trees to generate the third data structure. In other embodiments, the second machine learning model comprises a multi-layer neural network comprising an input layer, one or more hidden layers and an output layer. The input layer may comprise a first set of neurons which take as input a set of independent variables from the second data structure, and the output layer may comprise a second set of neurons corresponding to the two or more classes.

In step 206, at least a portion of a routing of at least a given one of the one or more IT assets from a first location to a second location is controlled based at least in part on the generated third data structure. Step 206 may comprise selecting the second location based at least in part on a given type of reverse logistics processing recommended for the given information technology asset. For example, if the given type of reverse logistics processing comprises recycling, the second location may be one which is configured to perform recycling (e.g., which may or may not be the same as a location configured to perform other types of reverse logistics processing, such as refurbishment). In some embodiments, the type of routing is also selected based at least in part on the given type of reverse logistics processing. For example, if the given type of reverse logistics processing comprises disposal, then a lower cost form of shipping may be selected than if other types of reverse logistics processing where recommended (e.g., if repair the type of routing may be selected so as to complete repairs in accordance with any warranty conditions or other service level agreements (SLAs), if refurbishment the type of routing may be selected so as to meet a current demand level for refurbished products, etc.). Step 206 may also or alternatively comprise selecting the second location based at least in part on determining a geographical demand for the given information technology asset processing utilizing a given type of reverse logistics processing recommended for the given information technology asset. For example, if the given type of reverse logistics processing comprises refurbishment or repacking, then the second location may be selected based on known or predicted demand for refurbished or repacked IT assets in different geographic regions.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for generating RLF option predictions for different issues.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

The trend of reverse logistics in computer and other IT asset manufacturing has evolved significantly over the years. Initially, manufacturers did not pay much attention to the Reverse Logistics Fulfilment (RLF) process, as the cost of RLF was often considered higher than the cost of simply disposing of old or defective products. However, with the growing awareness of environmental concerns and the increasing pressure to reduce waste and carbon footprint, manufacturers have started to focus more on reverse fulfilment. For example, some manufacturers have introduced or offered take-back programs for their products which enable customers or other users to return old or defective products to the manufacturer, with the manufacturer then recycling or refurbishing them as necessary. The trend of RLF in computer and other IT asset manufacturing has continued to grow. Many manufacturers now have dedicated reverse logistics teams and processes for handling the collection, refurbishment and recycling of their products. Additionally, new technologies and processes, such as remanufacturing, have emerged to further reduce waste and environmental impact.

Overall, the historical trend of reverse logistics in computer and other IT asset manufacturing has shifted from a focus on cost savings to a focus on sustainability and environmental responsibility. As a result, manufacturers are increasingly incorporating reverse logistics into their business strategies to optimize their operations, reduce waste, and improve their environmental impact.

RLF in the manufacturing industry involves the process of managing and optimizing the flow of products, components and materials from customers or other users back to the manufacturer or other designated destinations (e.g., third-party logistics (3PL) centers). This processing includes activities such as product returns, repairs, refurbishments, recycling, deconstruction, remanufacturing, and disposal. Decision-making in RLF in the manufacturing industry typically revolves around assessing the condition of returned products, determining the appropriate course of action for each returned product, and optimizing resource allocation to minimize costs and environmental impact.

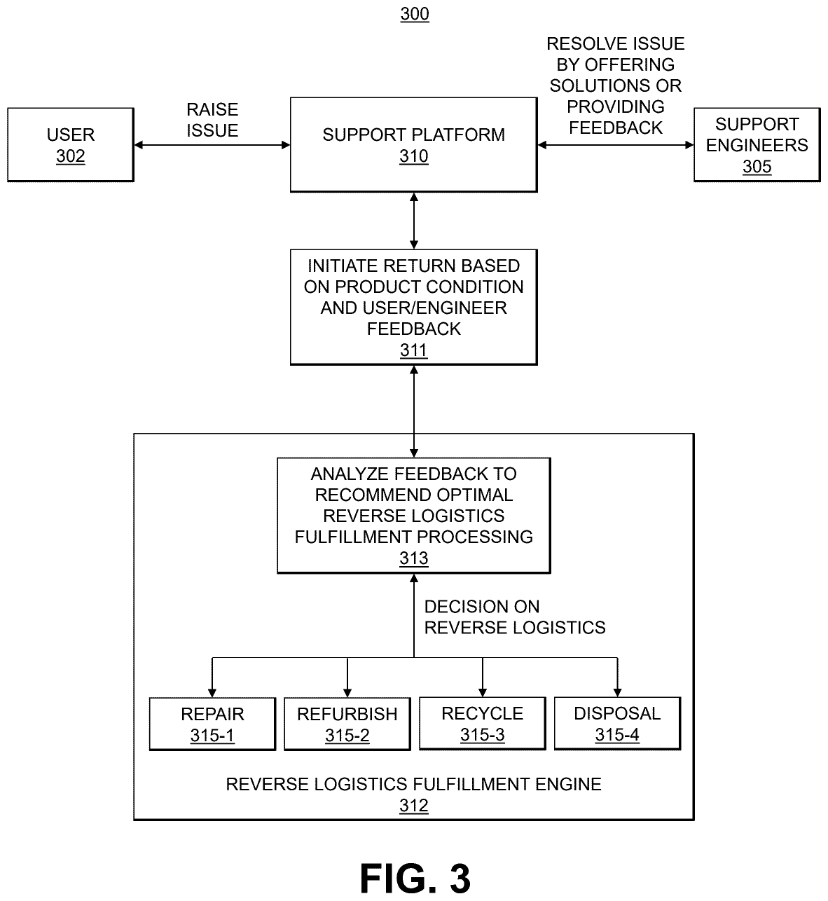

FIG. 3 shows a system 300 configured for managing RLF for an entity (e.g., a manufacturer of computers or other IT assets). In the system 300, a user 301 (e.g., a customer) raises one or more issues with a support platform 310 of the entity. One or more support engineers 305 of the entity attempt to resolve the raised issues by offering solutions (e.g., providing technical support to fix the issues) or providing feedback to one or more decision-making processes within the support platform 310. The support engineers 305, for example, can assess the raised issues remotely or on-site to resolve user problems. If the raised issues cannot be resolved, the support engineers 305 may provide feedback to the support platform 310 which may then initiate a return of one or more products (e.g., computers or other IT assets) associated with the raised issues. In response, the support platform 310 in block 311 may initiate a return based on the condition of the one or more products associated with the raised issues (e.g., as assessed by the support engineers 305), and based on feedback from the user 302 and/or the support engineers 305. In block 313, an RLF engine 312 analyzes the feedback to recommend optimal RLF processing for the returned products. The decision on reverse logistics may result in the RLF engine 312 initiating various tasks, such as a repair task 315-1, a refurbish task 315-2, a recycle task 315-3 and a disposal task 315-4.

Consider, as an example, a computer manufacturer with a commitment to offering warranties for its products. When customers or other users encounter issues with defective or faulty products, they seek assistance from a dedicated support team (e.g., the support engineers 305 associated with the support platform 310). This specialized team diligently investigates reported problems, employing remote analysis or conducting on-site visits as necessary. However, there are instances where the support engineers 305 are unable to rectify a reported issue, leading to the initiation of a return process for the product (e.g., block 311 in the system 300). In some cases, a returned product is collected and transported to a central facility. Subsequently, manual decisions are made concerning the appropriate actions to be taken for each returned product, encompassing factors like determining the shipping destination, assessing the feasibility of repair, refurbishment, recycling, identifying reusable components, etc., as well as identifying components that need to be properly disposed of. This manual approach, however, has various technical problems including time inefficiency, lack of effectiveness, and high costs.

Illustrative embodiments provide technical solutions for implementing the RLF engine 312 as a sophisticated, intelligent engine designed to conduct comprehensive intent and context analysis on feedback from the user 302 and the support engineers 305. The technical solutions can advantageously play a pivotal role in identifying the most optimal options for RLF, and for offering well-informed recommendations accordingly. In some embodiments, key considerations for RLF include determining the most suitable retrieval location for the user 302's returned product (e.g., a computer or other IT asset) and making sound judgments regarding the appropriate reverse logistics actions to be taken (e.g., repair, refurbishment, recycling of materials, responsible disposal, etc.). Through implementation of the intelligent RLF engine 312, the technical solutions are able to streamline and automate the decision-making process for RLF. The intelligent RLF engine 312 can leverage advanced technologies (e.g., including machine learning (ML)) to provide cost-effective and optimal or improved recommendations.

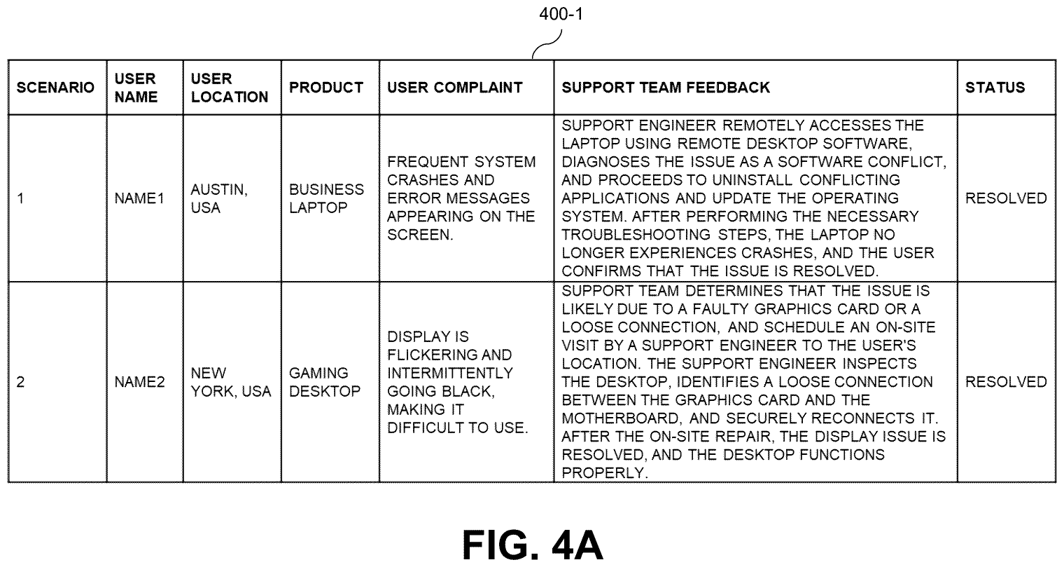

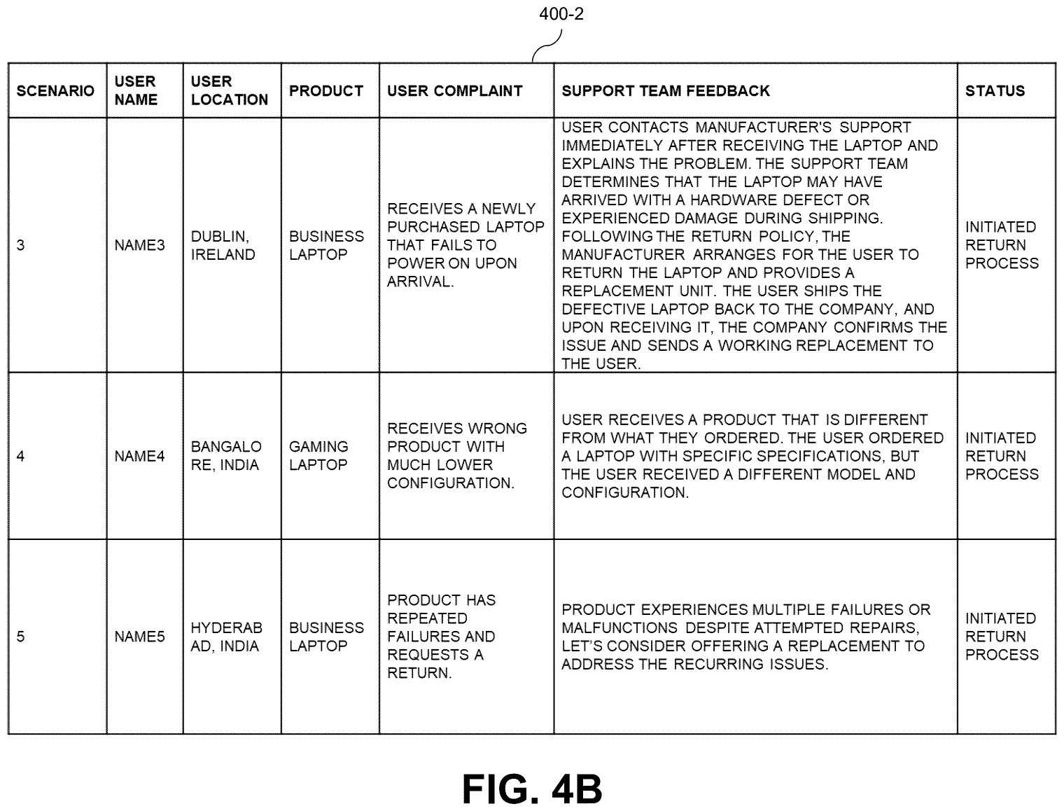

Customers, such as user 302 in the system 300, may encounter various situations where they have concerns or complaints about a product, seeking resolution or potentially requesting repairs or replacements via the support platform 310. FIGS. 4A and 4B show tables 400-1 and 400-2 illustrating examples of such situations or scenarios denoted 1 through 5. The tables 400-1 and 400-2 include columns for the scenario identifier (ID), user name, the user location, the affected product, the user complain, the support team feedback and the status. In scenarios 1 and 2 shown in table 400-1, the support engineers 305 associated with the support platform 310 are able to successfully resolve the issues. In scenarios 3, 4 and 5 shown in table 400-2, the support engineers 305 encountered difficulties in resolving the issues and as a result initiated return processing. The intelligent RLF engine 312 is configured to analyze the user complaints or issues as well as feedback from the support engineers 305 to make an informed decision regarding the most suitable approach for the RLF process in each scenario.

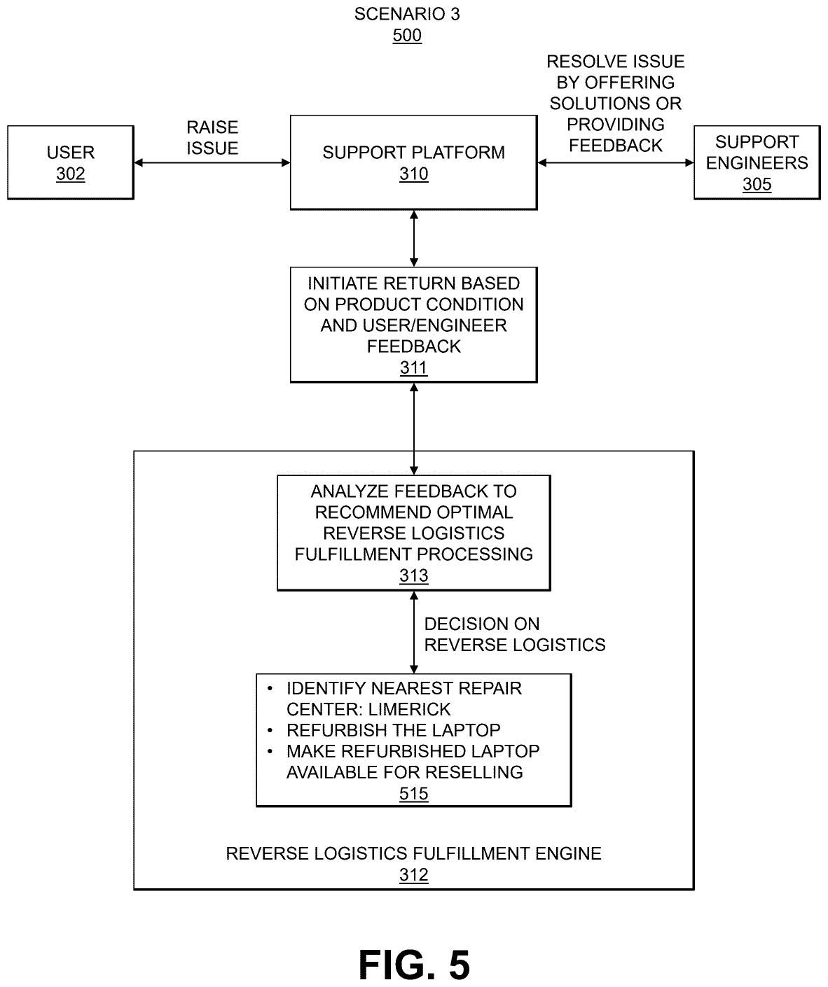

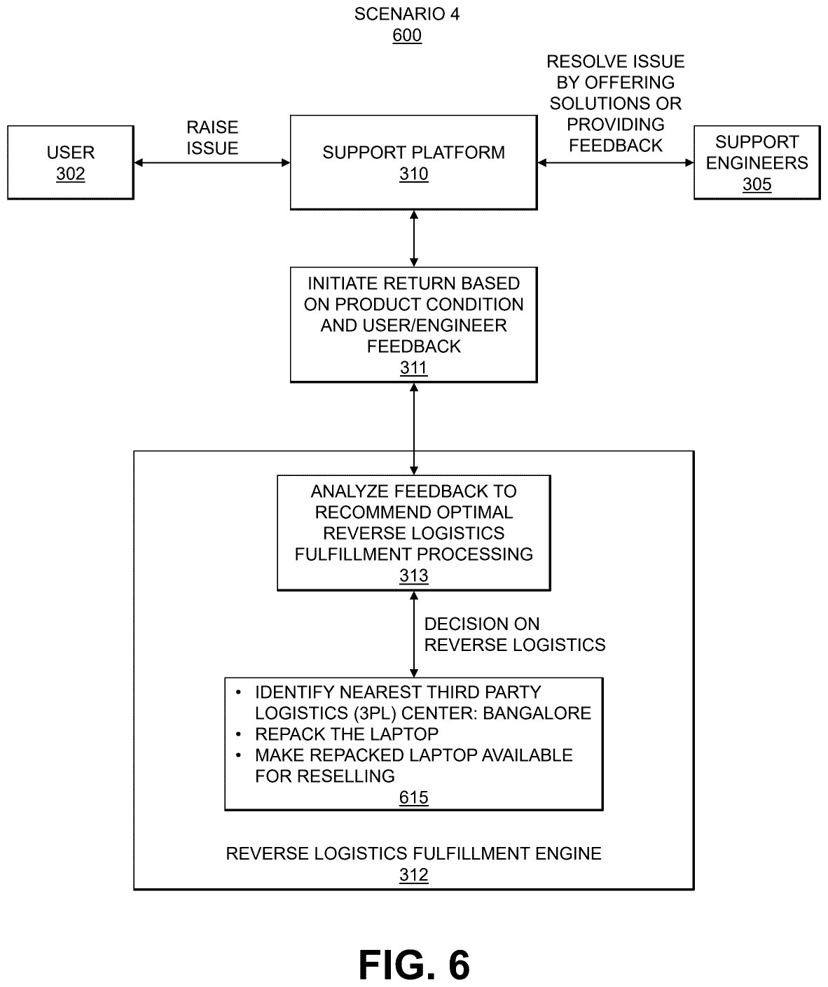

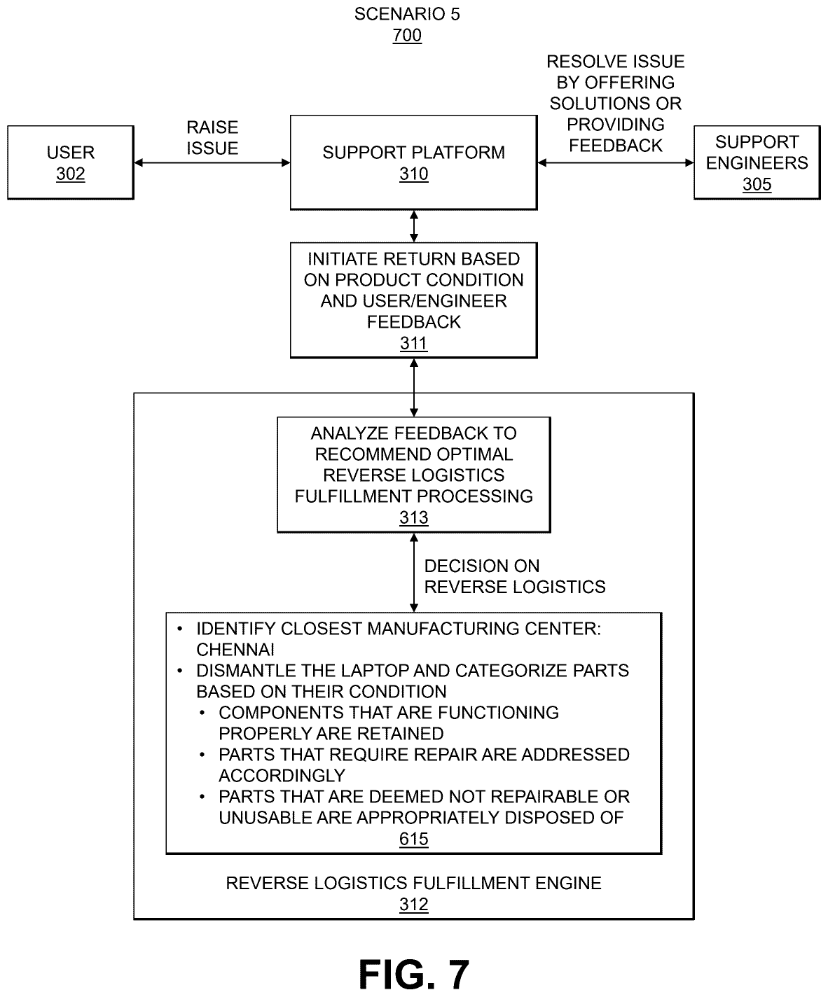

FIG. 5 shows an implementation 500 of the system 300 for scenario 3 in the table 400-2, where the decision on reverse logistics 515 by the RLF engine 312 includes identifying a nearest repair center, refurbishing the laptop, and making the refurbished laptop available for reselling. FIG. 6 shows an implementation 600 of the system 300 for scenario 4 in the table 400-2, where the decision on reverse logistics 615 by the RLF engine 312 includes identifying the nearest 3PL center, repacking the laptop, and making the repacked laptop available for reselling. FIG. 7 shows an implementation 700 of the system 300 for scenario 5 in the table 400-2, where the decision on reverse logistics 715 by the RLF engine 312 includes identifying the closest manufacturing center, and dismantling the laptop to categorize parts thereof based on their conditions (e.g., components that are functioning properly which may be retained, parts that require repair which are addressed accordingly, and parts that are deemed not repairable or unusable which are appropriately disposed of).

By making informed decisions at each stage of the RLF process, manufacturers can streamline operations, reduce waste, and enhance customer satisfaction. Effective decision-making in this context includes balancing factors such as repair costs, warranty terms, product value, environmental impact, and overall business objectives.

The lack of a comprehensive automated solution for analyzing returned systems or products based on various parameters poses a significant challenge in making informed decisions regarding the optimal actions to be taken in RLF processing. RLF processing, for example, includes determining whether a particular system should be repackaged, repaired, refurbished, deconstructed to salvage valuable components, recycled, or simply discarded. The absence of such a solution hinders an entity's ability to maximize the return value of products in question. Further, there is a notable absence of a dedicated solution that effectively assesses the demand for refurbished products across different geographical regions. This lack of a specialized tool impedes the ability to accurately gauge the market potential and identify viable opportunities for distributing refurbished items in specific locations. As a result, the optimization of resource allocation and the realization of maximum returns from refurbished products presents significant technical challenges.

The technical solutions described herein provide functionality for identifying RLF decisions as early as possible in the process (e.g., at a user location or closer to the user location) based on user feedback, performing classification by identifying the intent and the optimal option based on the condition of the product and routing to the right location or fulfilment action. In order to determine the optimal decision, in some embodiments the technical solutions perform continued analysis based on feedback received from users, and feedback regarding the fulfillment option decision which are taken and implemented over some period of time. The technical solutions may utilize an analysis engine which is configured to take as input the user reason for returns in order to recommend an optimal reverse fulfillment option.

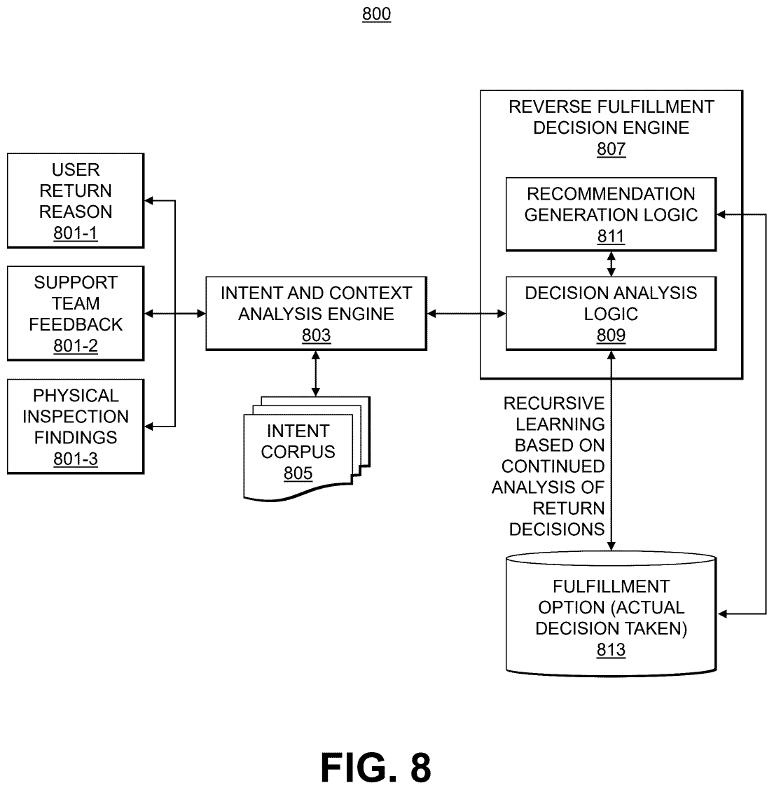

FIG. 8 shows a system 800 implementing an intelligent RLF framework. The system 800 includes an intent and context analysis engine 803, which takes as input user return reasons 801-1, support team feedback 801-2, and physical inspection findings 801-3. The intent and context analysis engine 803 utilizes such inputs 801-1, 801-2 and 801-3 (collectively, inputs 801) along with an intent corpus 805 to determine an intent which is provided to decision analysis logic 809 of a reverse fulfilment decision engine 807. The reverse fulfilment decision engine 807 further implements recommendation generation logic 811, which is configured to recommend RLF decisions for different scenarios. The reverse fulfillment decision engine 807 may implement recursive learning based on continued analysis of return decisions from a fulfilment option 813 data store (e.g., indicating the actual decisions taken for different scenarios, which may or may not be the same as the recommended decisions output by the recommendation generation logic 811).

The intent and context analysis engine 803 is configured to utilize natural language understanding (NLU) and one or more machine learning models or neural networks to analyze the inputs 801 and classify the intent. Considering a dialog message (e.g., one or more of the inputs 801) may be considered as a time series model where the words come one after another in time/space. Thus, some embodiments leverage a Recurrent Neural Network (RNN) for implementing the intent and context analysis engine 803. To better understand the context and analyze the inputs 801 most efficiently, a bi-directional RNN may be used which uses two separate processing sequences (e.g., one from left to right, and another from right to left). As RNNs have the tendency to have exploding or vanishing gradient issues for longer and complex inputs, the intent and context analysis engine 803 may utilize a specific type of bi-directional RNN referred to as bi-directional RNN with Long Short-Term Memory (LSTM) for the NLU processing.

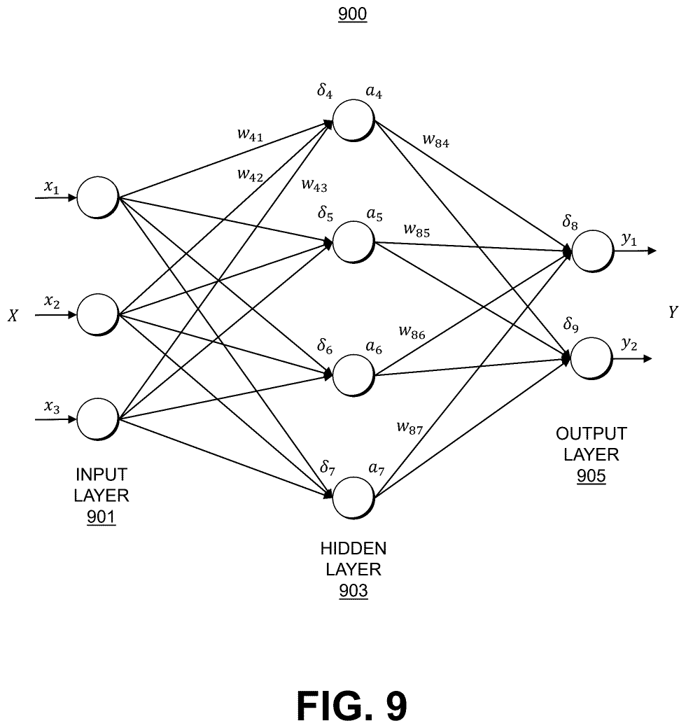

RNNs are a unique type of neural network, where the previous step's output feeds into the current step's input. In a traditional neural network, which is also referred to as a feed-forward network, the input and output are independent. In language processing, it is important to remember the previous words before predicting the next term of a sentence or other sequence. This is where RNNs makes a difference, by having the hidden state recognize some phrases in the sentence. If the sentences are too long, some of the previous information may not be available in the limited hidden state, which requires the bi-directional processing of the sentence (e.g., from past and future in two sequences in parallel) as done in a bi-directional RNN. LSTM introduces advanced memory units and gates to the RNN, which act like knobs or dials to improve the model's accuracy and performance. FIG. 9 shows an architecture 900 of a bi-directional LSTM network including an input layer 901, a hidden layer 903 and an output layer 905. The input layer 901 takes an input X (x₁, x₂, x₃) and inputs them to different neurons, which connect to neurons in the hidden layer 903, which then connect to neurons in the output layer 905 representing an output Y (y₁, y₂). Various weights, denoted wᵢⱼ, are applied between the neurons in the input layer 901, the hidden layer 903 and the output layer 905.

The intent analysis starts with a set of corpus data used to train the model (e.g., the intent corpus 805). This corpus data contains words and phrases of sentences, along with the intent associated with each of the sentences. The dataset may be preprocessed to clean any unwanted characters and stop words. This may also include stemming and lemmatization, changing text to lowercase, removing punctuation, flawed characters, etc. Once pre-processing and data cleanup is done, the input list of words (e.g., in the sentence) is tokenized. Various approaches may be used for tokenization, including the Keras library, the National Language Toolkit (NLTK) library, etc. In some embodiments, it is assumed that the Keras Tokenizer class is used to index the tokens. After tokenization is done, the tokens are padded to make them of equal length to be used in the ML model. For output encoding, the same thing is done (e.g., tokenization and padding) to the intent list of the intent corpus 805. As a result, the intent list is indexed and ready to be fed into the ML model. The intent list may be one-hot encoded before being provided to the ML model. The corpus containing the intent data (e.g., the intent corpus 805) is used to train the ML model before predicting the intent for an incoming message (e.g., one or more of the inputs 801).

The bi-directional RNN model with LSTM may be created using the Keras library. Various parameters are passed during the creation of the model, including use of the Adam optimizer, selection of Softmax as the activation function, a number of epochs, etc. These parameters, including batch size and periods or epochs, may be tuned to get the best performance and accuracy of the model. After the model is trained with the intent corpus 805, it can predict the intent of the inputs 801. The accuracy of the model is calculated as well for hyperparameter tuning.

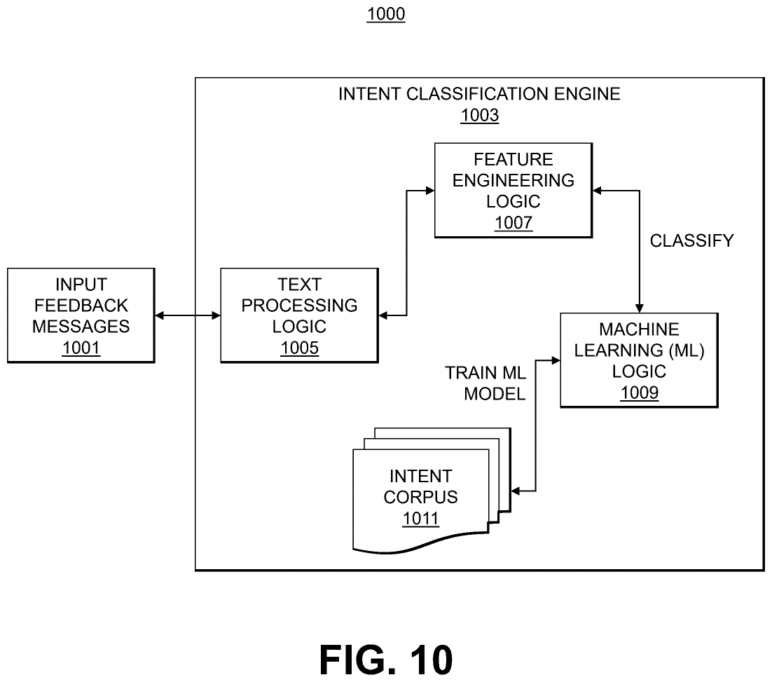

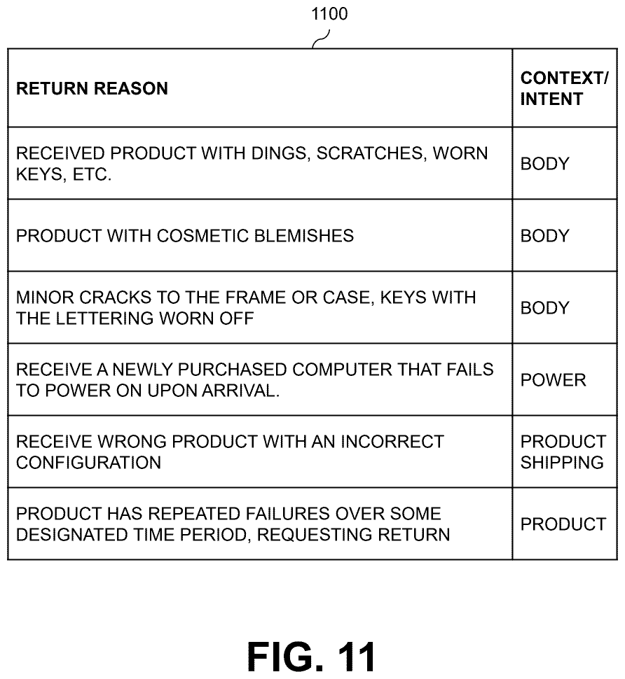

FIG. 10 shows an architecture 1000 of a conversational intent analyzer, including an input feedback message 1001 which is input to an intent classification engine 1003. The intent classification engine 1003 is configured to implement text processing logic 1005, which performs NLU of the input feedback messages 1001. The processed text is then provided to feature engineering logic 1007, which extract features to be utilized for intent classification by ML logic 1009 (e.g., implementing a bi-directional RNN model with LSTM or another suitable ML model or neural network). The ML logic 1009 utilizes an intent corpus 1011 for training of the ML model implemented by the ML logic 1009. FIG. 11 shows a table 1100 illustrating various return reasons and their associated context or intent.

As discussed above, determining intent is important for determining RLF options. By tokenizing the motive, the context or intent can be determined. If the product's body or housing is damaged, for example, then options for repair, refurbishment and shipping-related resale are available as RLF options. Nonetheless, profound learning is useful for determining an appropriate RLF option for any given scenario. Using the intent and deep learning approaches, the optimal RLF option is predicted as discussed in further detail below.

In some embodiments, shallow learning and/or deep learning approaches are used to build the classification models for predicting an optimal RLF option. This helps in deciding on the algorithm based on the accuracy and the performance of the models. The shallow learning approach is appropriate when there are fewer data dimensions and less effort is expected for training the model. As a shallow learning option, an ensemble bagging technique with a Random Forest (RF) algorithm may be utilized for multi-class classification for predicting the optimal RLF option. The RF may be chosen for prediction and recommendation because of its efficiency and accuracy of processing huge volumes of data. RF uses “bagging” (bootstrap aggregating) to generate predictions. This includes utilizing multiple classifiers (e.g., in parallel) each trained on different data samples and different features. This reduces the variance and the bias stemming from using a single classifier. The final classification may be achieved by aggregating the predictions made by the different classifiers.

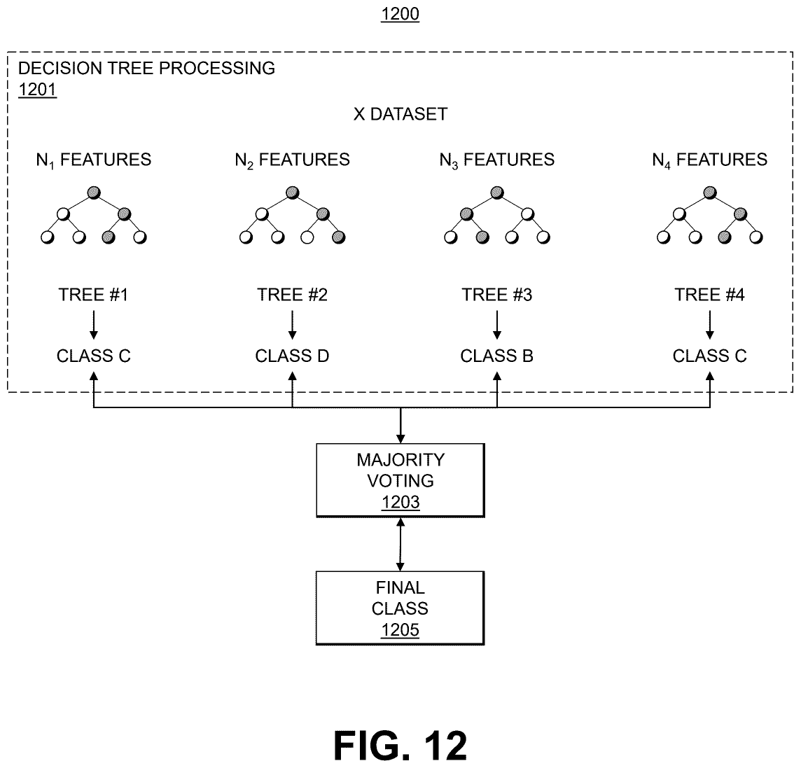

FIG. 12 shows an architecture 1200 of a RF classifier, including decision tree processing 1201 where different decision trees (denoted #1, #2, #3 and #4) are constructed using different sets of features (denoted N₁, N₂, N₃ and N₄) to produce different classifications. Majority voting is applied in block 1203, followed by determining a final class in block 1205. As shown in FIG. 12, the RF is composed of multiple decision trees, and each decision tree is constructed using different features and different data samples which reduces the bias and variance. In the training process, the decision trees are constructed using the training data, and in the testing process each new prediction that needs to be made runs through the different decision trees, with each decision tree yielding a score and where the final class 1205 is determined by majority voting 1203 (e.g., which class got the majority of the votes among the multiple decision trees).

The RF classifier may use multinomial or multi-class classification, meaning that the results of the classification would be one of a few types of classes. Each class is a different RLF option, so there are potentially multiple classes. The model predicts on the classes (e.g., RLF options) with a confidence score. The multiple independent variables (X values) are the state of the product, product feedback intent, cost to fix, earlier routing options, etc. The target variable (Y value) is the RLF option which is predicted or recommended by the model.

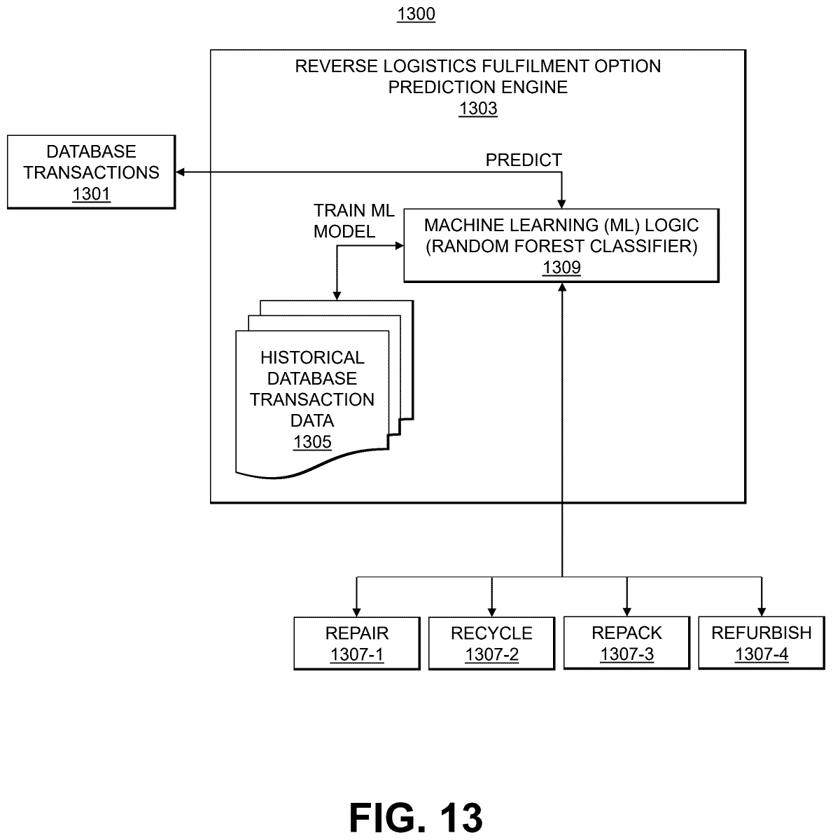

FIG. 13 shows a system 1300 implementing an RLF option prediction engine 1303 which acts on a set of database transactions 1301 (e.g., input such as inputs 801). The RLF option prediction engine 1303 utilizes historical database transaction data 1305 for training a ML model utilized by ML logic 1309 (e.g., a RF classifier), which predicts or recommends RLF options such as repair 1307-1, recycle 1307-2, repack 1307-3, and refurbish 1307-4. The RLF option prediction engine 1303 may, in some embodiments, by built using SciKitLearn (sklearn) libraries with the Python programming language.

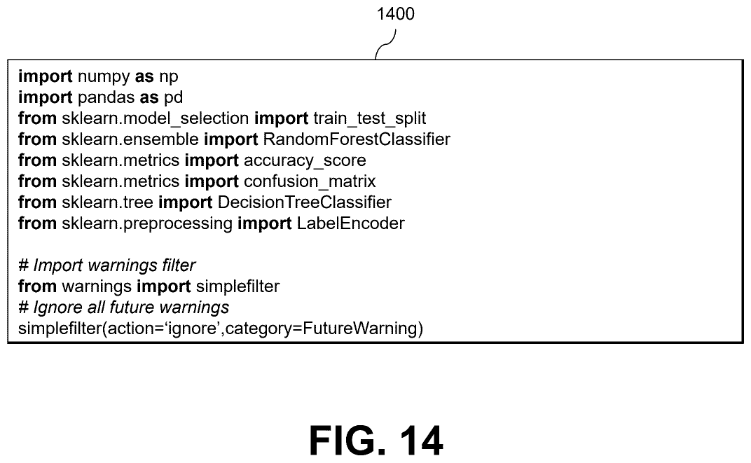

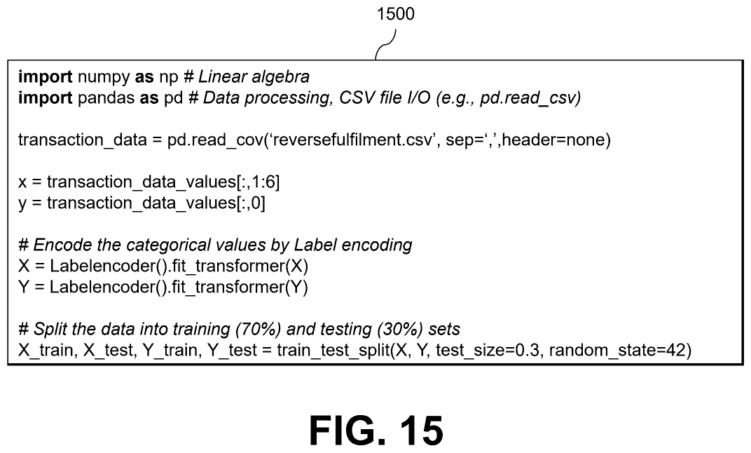

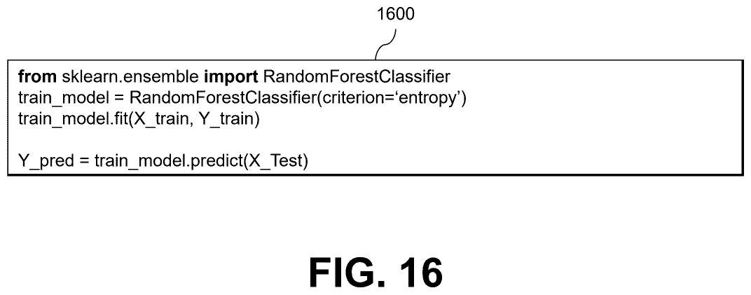

Sample pseudocode for achieving multi-class prediction with a shallow learning approach will now be described with respect to FIGS. 14-16. FIG. 14 shows pseudocode 1400 for importing the necessary libraries, such as sklearn, pandas, numpy, etc. The next step is to read RLF transaction history (e.g., historical database transaction data 1305) to create a training data set. The data may be created as a comma separated value (CSV) file, and the data may be read as a Pandas data frame. The data is separated into the independent variables or features (X) and the dependent variable or target value (Y) based on the position of the column in the data frame. The categorical data in both the features and target values are encoded by passing to LabelEncoder. Then the data is split into training and testing data sets using the train_test_split function of the sklearn library. In some embodiments, the training data set includes 70% of the observations and the testing data set includes 30% of the observations. FIG. 15 shows pseudocode 1500 for creating the training data set. A RF classifier is created using the sklearn library, with the criterion hyperparameters as “entropy.” The model is trained using the training data set, both the independent variables (X_train) and the target variable (Y_train). Once trained, the model is asked to predict by passing the test data of the independent variables (X_test). The predictions, accuracy and confusion matrix are printed or output. Hyperparameter tuning may be performed to improve the accuracy of the model. FIG. 16 shows pseudocode 1600 for creating and training the RF classifier.

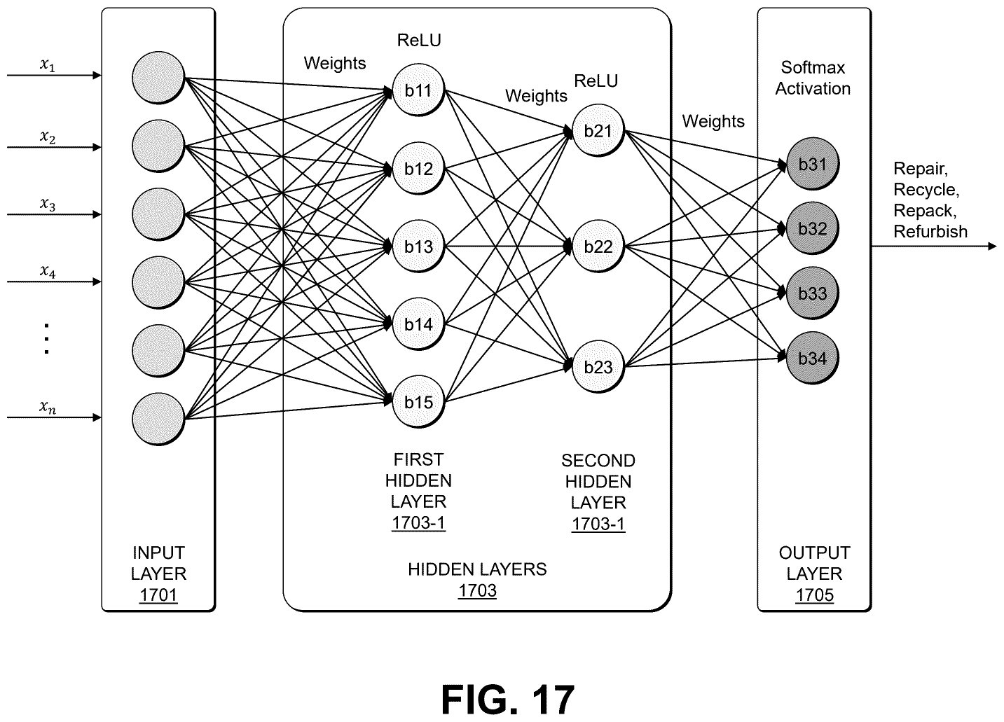

A deep learning approach is appropriate when there is a huge amount of data with a lot of dimensions involved. In such situations, the technical solutions may leverage multi-layer perception (MLP) or an artificial neural network (ANN) as a classifier. Such approaches utilize a deep neural network by building a dense, multi-layer neural network to act as a sophisticated multi-class classifier (e.g., for predicting different RLF options). This neural network includes an input layer, one or more hidden layers, and an output layer. FIG. 17 shows an architecture 1700 of a deep neural network configured for predicting the optimal RLF option for a given scenario, which includes an input layer 1701, hidden layers 1703-1 and 1703-2 (collectively, hidden layer 1703) and an output layer 1705. The input layer 1701 includes a number of neurons that matches the number of input/independent variables (X). The hidden layer 1703 includes hidden layer 1703-1 and hidden layer 1703-2, which each include a number of neurons which depend on the number of neurons in the input layer 1701. The output layer 1705 in the FIG. 17 example includes four neurons matching the number of classes (e.g., repair, recycle, repack, refurbish) in the multi-class prediction model. It should be appreciated, however, that the number of classes may vary depending on the available RLF options. In some embodiments, for example, additional classes are utilized for deconstruction, disposal, etc.

Although in the FIG. 17 example there are five neurons in the first hidden layer 1703-1 and three neurons in the hidden layer 1703-2, the actual values may depend on the total number of neurons in the input layer 1701. The number of neurons in the first hidden layer 1703-1, for example, may be calculated based on an algorithm of matching the power of 2 to the number of neurons in the input layer 1701. For example, if the number of input variables is 19, it falls in the range of 25 meaning that the first hidden layer 1703-1 will have 32 neurons. The second hidden layer 1703-2 will have 24 (16) neurons. If a third hidden layer were used, it would include 23 (8) neurons, and so forth. The neurons in the hidden layer 1703 and the output layer 1705 include an activation function which drives if the neurons will fire or not. In the architecture 1700, the Rectified Linear Unit (ReLU) activation function is used for the hidden layer 1703. The neurons in the output layer 1705 utilize the Softmax activation function, as the model is constructed to behave as a multi-class classifier.

Considering that the architecture 1700 is a dense neural network, each node or neuron will connect with each other. Each connection will have a weight factor, and the nodes or neurons will have bias factors. The weight and bias values may be set randomly by the neural network, and may start as 1 or 0 for all the values. Each neuron or node does a linear calculation by combining the multiplication of each input variable (x₁, x₂, . . . xₙ) with their weight factors and then adding the bias of the neuron according to the following:

$$w s 1 = {x}_{1} {w}_{1} + {x}_{2} {w}_{2} + … + {b}_{1}$$

where ws1 is the weighted sum of the neuron 1, x₁, x₂, etc. are the input values to the model, w₁, w₂, etc. are the weight values applied to the connections to neuron 1, and b₁ is the bias value of neuron 1. This weighted sum is input to an activation function (e.g., ReLU in the example of FIG. 17) to compute the value of the activation function. Similarly, weighted sums and activation function values are calculated for all other neurons in the layer, with such values being fed to the neurons of the next layer. This process is repeated until the values are fed to the neurons of the output layer 1705, where the weighted sum is calculated and compared to an actual target value. Depending on the difference, the loss value is calculated. This pass through of the neural network is a forward propagation which calculates the error and drives a backpropagation through the network to minimize the loss or error at each neuron of the network. Considering the error/loss is generated by all the neurons in the network, backpropagation goes through each layer from back to forward and tries to minimize the loss by using gradient descent-based optimization. Considering the neural network is used as a multi-class classifier, a “categorical_crossentropy” loss function is used along with the Adam (adaptive moment estimation) optimization algorithm, with “accuracy” as the metric. Various other loss functions, optimization algorithms and metrics may be utilized in other embodiments. For example, the RMSProp (root mean square propagation) optimization algorithm may be used in place of the Adam optimization algorithm.

The result of the backpropagation is to adjust the weight and bias values at each connection and neuron level to reduce the error/loss. Once all the observations of the training data are passed through the neural network, an epoch (e.g., epoch 1) is completed. Another forward propagation is initiated with the adjusted weight and bias values, which are considered epoch 2 and the same process of forward and backpropagation is repeated in epoch 2 and subsequent epochs. This process of repeating the epochs results in the reduction of the loss to a very small number (e.g., close to 0) at which point the neural network is considered to be sufficiently trained for prediction.

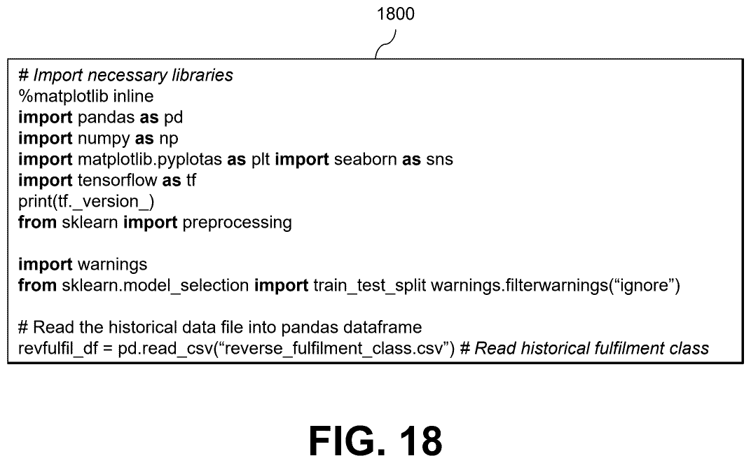

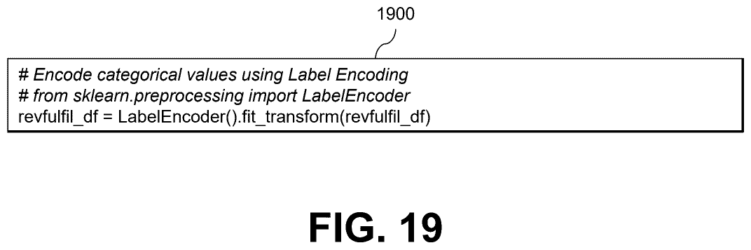

Sample pseudocode for achieving multi-class prediction with a deep learning approach will now be described with respect to FIGS. 18-22. In the example of FIGS. 18-22, the RLF option prediction engine 1303 is built using Keras with a TensorFlow backend, the Python programming language, and using Pandas, Numpy and SciKitLearn (sklearn) libraries. First, data preprocessing is performed. The dataset of database transaction metrics from the historical data repository is read and a Pandas data frame is generated. This contains all the columns including the independent variables and the dependent/target variable column (e.g., the RLF option). The initial step will be to conduct pre-processing of the data to handle any null or missing values in the columns. Null/missing values in numerical columns can be replaced by the median value of that column. After doing initial data analysis by creating some univariate and bivariate plots of these columns, the importance and influence of each of the columns can be understood. Columns that are determined to have no role or influence on the actual prediction (e.g., the target variable) may be dropped. FIG. 18 shows pseudocode 1800 for importing the necessary libraries, and for reading the RLF transaction history (e.g., historical database transaction data 1305), where the data may be read as a Pandas data frame. As ML models deal with numerical values, textual categorical values in the columns must be encoded during the data preprocessing stage. This can be achieved by using the LabelEncoder function which is part of the sklearn library, as shown in the pseudocode 1900 of FIG. 19.

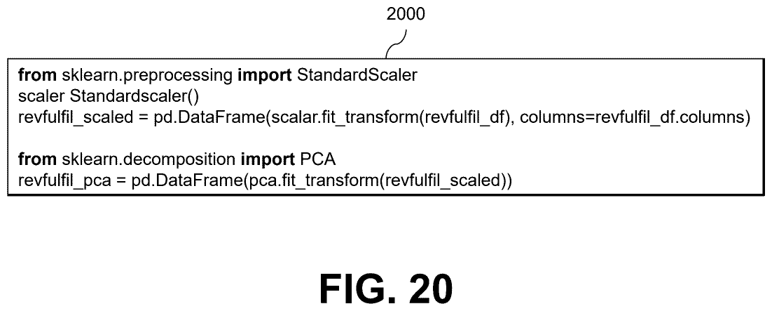

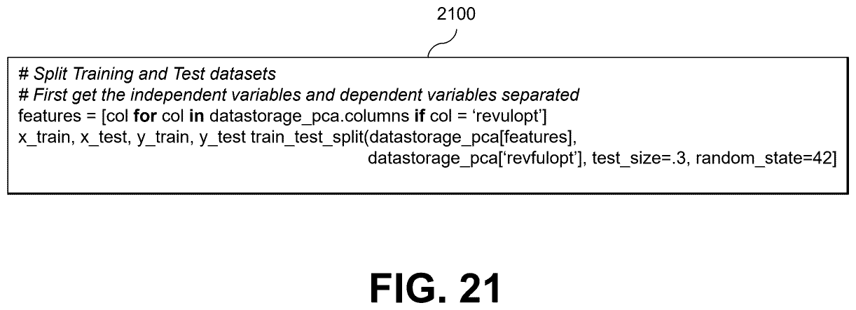

The next step is to reduce the dimensionality of the dataset by applying principal component analysis (PCA). Before this, the dataset is normalized by applying scaling. This can be achieved using the StandardScaler function available in the sklearn library. After normalization, the data can be passed to the PCA function for dimensionality reduction and made ready for model training as shown in the pseudocode 2000 of FIG. 20. The whole dataset is split into training and testing datasets using the train_test_split function of the sklearn library (e.g., with a 70%-30% training-testing split) as shown in the pseudocode 2100 of FIG. 21. Considering this is a multi-class prediction and a dense neural network is used as the model, it is important to scale the data before it is passed to the model. Since scaling is already done before PCA, however, there is no need to scale it again. At the end of these activities, the data is read for model training/testing.

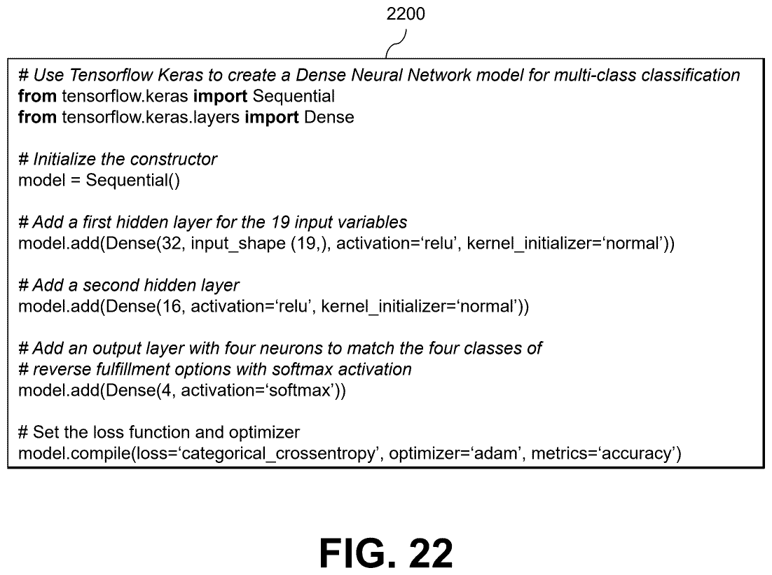

A multi-layer dense neural network is created using the Keras library to act as the multi-class classifier. Using the function Model( ), the functional model is created, and then individual layers of each branch are added by calling the add( ) function of the model and passing an instance of Dense( ) to indicate that it is a dense neural network. That way, all the neurons in each layer will connect with all the neurons from the preceding and following layer. The Dense( ) function will accept parameters for the number of neurons in that layer, the type of activation function to use, and if there are any kernel parameters. Multiple hidden layers are added by calling the same add( ) function to the model, as well as the output layer. Once the model is created, a loss function, optimizer type and validation metrics are added to the model using the compile( ) function. In some embodiments, “categorical_crossentropy” is used as the loss function, Adam is used as the optimizer, and “accuracy” is used as the metrics. Other embodiments, however, may use other loss functions, optimizers and metrics. FIG. 22 shows pseudocode 2200 for creating of the multi-layer dense neural network.

Model training, validation and prediction are then performed using the created model. Neural network model training may be achieved by calling a fit( ) function of the model, and passing training data and a number of epochs. After the model completes the specified number of epochs, it is considered trained and ready for validation. The loss/error value can be obtained by calling the evaluate( ) function of the model and passing the test data. This loss value indicates how well the model is trained. A higher loss value means the model is not trained enough, so hyperparameter tuning is required. Typically, the number of epochs can be increased to train the model more. Other hyperparameter tuning can be done by changing the loss function, changing the optimizer algorithm, changing the neural network architecture (e.g., by adding more hidden layers). Once the model is fully trained with a reasonable loss/error value (e.g., as close to 0 as possible), it is ready for prediction. Prediction of the model is achieved by calling the predict( ) function of the model and passing the independent variables of test data (e.g., for comparing training vs testing) or real values for which an RLF option (e.g., the target variable) is to be predicted.

The technical solutions described herein provide for optimal RLF option prediction which optimizes cost with zero impact and without affecting reverse logistics planning. The technical solutions also provide a mechanism for deriving the confidence level of predicted RLF options (e.g., repack, refurbish, repair, recycle, deconstruct, dispose, etc.). Thus, the technical solutions enable reverse logistics teams to conduct dynamic analysis to investigate and determine the ideal RLF options for different scenarios. The predicted RLF options may, in some cases, reverse the delivery to optimize cost, including determining optimal routing cost based on destination and product condition, and determining actions to be taken at the destination such as repacking, refurbishing, repairing, recycling, deconstructing, disposal, etc.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based reverse logistics processing will now be described in greater detail with reference to FIGS. 23 and 24. Although described in the context of system 100, these platforms may also be used to implement at least portions of other information processing systems in other embodiments.

FIG. 23 shows an example processing platform comprising cloud infrastructure 2300. The cloud infrastructure 2300 comprises a combination of physical and virtual processing resources that may be utilized to implement at least a portion of the information processing system 100 in FIG. 1. The cloud infrastructure 2300 comprises multiple virtual machines (VMs) and/or container sets 2302-1, 2302-2, . . . 2302-L implemented using virtualization infrastructure 2304. The virtualization infrastructure 2304 runs on physical infrastructure 2305, and illustratively comprises one or more hypervisors and/or operating system level virtualization infrastructure. The operating system level virtualization infrastructure illustratively comprises kernel control groups of a Linux operating system or other type of operating system.

The cloud infrastructure 2300 further comprises sets of applications 2310-1, 2310-2, . . . 2310-L running on respective ones of the VMs/container sets 2302-1, 2302-2, . . . 2302-L under the control of the virtualization infrastructure 2304. The VMs/container sets 2302 may comprise respective VMs, respective sets of one or more containers, or respective sets of one or more containers running in VMs.

In some implementations of the FIG. 23 embodiment, the VMs/container sets 2302 comprise respective VMs implemented using virtualization infrastructure 2304 that comprises at least one hypervisor. A hypervisor platform may be used to implement a hypervisor within the virtualization infrastructure 2304, where the hypervisor platform has an associated virtual infrastructure management system. The underlying physical machines may comprise one or more distributed processing platforms that include one or more storage systems.

In other implementations of the FIG. 23 embodiment, the VMs/container sets 2302 comprise respective containers implemented using virtualization infrastructure 2304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 2300 shown in FIG. 23 may represent at least a portion of one processing platform. Another example of such a processing platform is processing platform 2400 shown in FIG. 24.

The processing platform 2400 in this embodiment comprises a portion of system 100 and includes a plurality of processing devices, denoted 2402-1, 2402-2, 2402-3, . . . 2402-K, which communicate with one another over a network 2404.

The network 2404 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2402-1 in the processing platform 2400 comprises a processor 2410 coupled to a memory 2412.

The processor 2410 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2412 may comprise random access memory (RAM), read-only memory (ROM), flash memory or other types of memory, in any combination. The memory 2412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2402-1 is network interface circuitry 2414, which is used to interface the processing device with the network 2404 and other system components, and may comprise conventional transceivers.

The other processing devices 2402 of the processing platform 2400 are assumed to be configured in a manner similar to that shown for processing device 2402-1 in the figure.

Again, the particular processing platform 2400 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based reverse logistics processing as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate a first data structure characterizing one or more issues encountered on one or more information technology assets;
to generate a second data structure by parsing the first data structure utilizing a first machine learning model, the second data structure characterizing a context of the one or more issues encountered on the one or more information technology assets;
to generate a third data structure utilizing a second machine learning model, the second machine learning model taking as input the second data structure, the third data structure characterizing one or more recommendations for one or more types of reverse logistics processing to be utilized for the one or more information technology assets; and
to control at least a portion of a routing of at least a given one of the one or more information technology assets from a first location to a second location based at least in part on the generated third data structure.

2. The apparatus of claim 1 wherein the first data structure comprises text data, and wherein the first machine learning model comprises one or more natural language understanding machine learning models configured to determine sentiment of the text data.

3. The apparatus of claim 2 wherein the first machine learning model comprises a bi-directional recurrent neural network with long short-term memory.

4. The apparatus of claim 2 wherein the text data comprises user-generated descriptions of the one or more issues encountered on the one or more information technology assets.

5. The apparatus of claim 2 wherein the text data comprises support engineer feedback related to the one or more issues encountered on the one or more information technology assets.

6. The apparatus of claim 2 wherein the text data comprises a description of a physical condition of the one or more information technology assets.

7. The apparatus of claim 1 wherein the context of the one or more issues encountered on the one or more information technology assets characterizes a cause of the one or more issues encountered on the one or more information technology assets.

8. The apparatus of claim 1 wherein the second machine learning model comprises a multi-class classifier configured to predict a given class from among a set of two or more classes, the set of two or more classes comprising two or more different reverse logistics fulfilment options.

9. The apparatus of claim 8 wherein the two or more different reverse logistics fulfilment options comprises at least two of repair, refurbish, recycle, repacking, remanufacturing, deconstruction and salvage, and disposal.

10. The apparatus of claim 8 wherein the second machine learning model comprises a random forest classifier comprising a plurality of decision trees trained on at least one of different data samples and different data features, the random forest classifier being configured to perform aggregation of class predictions from the plurality of decision trees to generate the third data structure.

11. The apparatus of claim 8 wherein the second machine learning model comprises a multi-layer neural network comprising an input layer, one or more hidden layers and an output layer.

12. The apparatus of claim 11 wherein the input layer comprises a first set of neurons which take as input a set of independent variables from the second data structure, and wherein the output layer comprises a second set of neurons corresponding to the two or more classes.

13. The apparatus of claim 1 wherein controlling at least a portion of the routing of the given information technology asset from the first location to the second location based at least in part on the generated third data structure comprises selecting the second location based at least in part on a given type of reverse logistics processing recommended for the given information technology asset.

14. The apparatus of claim 1 wherein controlling at least a portion of the routing of the given information technology asset from the first location to the second location based at least in part on the generated third data structure comprises selecting the second location based at least in part on determining a geographical demand for the given information technology asset processing utilizing a given type of reverse logistics processing recommended for the given information technology asset.

15. A computer program product comprising a non-transitory processor-readable storage medium having stored therein program code of one or more software programs, wherein the program code when executed by at least one processing device causes the at least one processing device:
to generate a first data structure characterizing one or more issues encountered on one or more information technology assets;
to generate a second data structure by parsing the first data structure utilizing a first machine learning model, the second data structure characterizing a context of the one or more issues encountered on the one or more information technology assets;
to generate a third data structure utilizing a second machine learning model, the second machine learning model taking as input the second data structure, the third data structure characterizing one or more recommendations for one or more types of reverse logistics processing to be utilized for the one or more information technology assets; and
to control at least a portion of a routing of at least a given one of the one or more information technology assets from a first location to a second location based at least in part on the generated third data structure.

16. The computer program product of claim 15 wherein the first data structure comprises text data, and wherein the first machine learning model comprises one or more natural language understanding machine learning models configured to determine sentiment of the text data.

17. The computer program product of claim 15 wherein the second machine learning model comprises a multi-class classifier configured to predict a given class from among a set of two or more classes, the set of two or more classes comprising two or more different reverse logistics fulfilment options.

18. A method comprising:
generating a first data structure characterizing one or more issues encountered on one or more information technology assets;
generating a second data structure by parsing the first data structure utilizing a first machine learning model, the second data structure characterizing a context of the one or more issues encountered on the one or more information technology assets;
generating a third data structure utilizing a second machine learning model, the second machine learning model taking as input the second data structure, the third data structure characterizing one or more recommendations for one or more types of reverse logistics processing to be utilized for the one or more information technology assets; and
controlling at least a portion of a routing of at least a given one of the one or more information technology assets from a first location to a second location based at least in part on the generated third data structure;
wherein the method is performed by at least one processing device comprising a processor coupled to a memory.

19. The method of claim 18 wherein the first data structure comprises text data, and wherein the first machine learning model comprises one or more natural language understanding machine learning models configured to determine sentiment of the text data.

20. The method of claim 18 wherein the second machine learning model comprises a multi-class classifier configured to predict a given class from among a set of two or more classes, the set of two or more classes comprising two or more different reverse logistics fulfilment options.
